(19) United States
(12) Patent Application Publication
(10) Pub. No.: US 2024/0284381 A1
(43) Pub. Date: Aug. 22, 2024

(54) METHOD AND APPARATUS FOR LOCATION ESTIMATION IN COMMUNICATION SYSTEM

(71) Applicant: ELECTRONICS AND TELECOMMUNICATIONS RESEARCH INSTITUTE, Daejeon (KR)

(72) Inventor: Ji Hung KIM, Daejeon (KR)

(73) Assignee: ELECTRONICS AND TELECOMMUNICATIONS RESEARCH INSTITUTE, Daejeon (KR)

(21) Appl. No.: 18/443,940

(22) Filed: Feb. 16, 2024

(30) Foreign Application Priority Data
Feb. 17, 2023 (KR) 10-2023-0021217
Feb. 8, 2024 (KR) 10-2024-0019605

(51) Int. Cl. H04W 64/00; H04B 7/185

(52) U.S. Cl. CPC H04W 64/00; H04B 7/18547

(57) ABSTRACT

A method of a satellite may comprise: transmitting a request signal requesting a terminal to periodically report assistance information for round-trip time calculation; receiving the assistance information periodically reported from the terminal; calculating round-trip times based on the assistance information; and estimating a location of the terminal using the round trip times.

### CROSS-REFERENCE TO RELATED APPLICATIONS

This application claims priority to Korean Patent Applications No. 10-2023-0021217, filed on Feb. 17, 2023, and No. 10-2024-0019605, filed on Feb. 8, 2024, with the Korean Intellectual Property Office (KIPO), the entire contents of which are hereby incorporated by reference.

### BACKGROUND

### 1. Technical Field

Exemplary embodiments of the present disclosure relate to a position estimation technique in a communication system, and more specifically, to a position estimation technique for a communication system, which allows a terminal location to be estimated based on a network in long-distance communication.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, a communication system may prepare for communication disruptions that may occur in cellular shadow areas, such as mountainous areas, desert areas, islands, and oceans, as well as in areas where terrestrial networks are disrupted due to various disasters such as earthquakes, tsunamis, and war. For this purpose, a spatial mobile communication network may be required. Since the spatial mobile communication network is maintained even when terrestrial networks are disrupted due to disaster or calamity, the area where the disaster or calamity occurred may not be disconnected from the outside world, making it possible to maintain individual survival and safety. Additionally, the spatial mobile communication network may be required to construct a hyper-connected society by providing mobile communication services to areas where communication was previously impossible, such as mountainous and remote areas without communication infrastructure.

A non-terrestrial network (NTN) constructed in such a spatial mobile communication system may have a relatively long round trip time (RTT) delay and a high Doppler shift environment compared to terrestrial communications. In this case, the long RTT may affect various procedures of data transmission/reception. Accordingly, in the NTN, if appropriate timing adjustment is not performed in the terminals, signals arriving at the base station from terminals located at various distances may have large differences in arrival times. Additionally, cell coverage may be large in the NTN, and division of cell coverage into extra-territorial regions may be required. Therefore, the NTN may necessitate a network-based terminal location estimation method suitable for long-distance communication.

### SUMMARY

Exemplary embodiments of the present disclosure are directed to providing a method and an apparatus for position estimation in a communication system, which allow a terminal location to be estimated based on a network in long-distance communication.

According to a first exemplary embodiment of the present disclosure, a method of a satellite may comprise: transmitting a request signal requesting a terminal to periodically report assistance information for round-trip time calculation; receiving the assistance information periodically reported from the terminal; calculating round-trip times based on the assistance information; and estimating a location of the terminal using the round trip times.

The assistance information may be a required transmission time, which is a time difference between an arrival time of a downlink signal transmitted from the satellite to the terminal and a transmission time of an uplink signal in response to the downlink signal, and in the calculating of the round-trip times based on the assistance information, the satellite may calculate the round-trip times using the required transmission times which are the periodically reported assistance information.

The assistance information may be a timing advance, and in the calculating of the round-trip times based on the assistance information, the satellite may calculate the round-trip times using the timing advances which are the periodically reported assistance information.

The estimating of the location of the terminal using the round trip times may comprise: calculating distances between the terminal and the satellite using the round-trip times; and estimating the location of the terminal based on the distances.

The method may further comprise: when a plurality of locations are estimated, calculating an angle of arrival for an uplink signal transmitted from the terminal; and determining one actual location from the plurality of locations using the calculated angle of arrival.

The method may further comprise: when a plurality of locations are estimated, acquiring a location of another terminal having round trip times closest to the calculated round trip times; and obtaining one actual location from the plurality of locations based on the acquired location of the another terminal.

The method may further comprise: transmitting ephemeris information of the satellite to the terminal, wherein the assistance information is information calculated by the terminal based on predicted locations of the satellite based on the ephemeris information.

The method may further comprise: transmitting information on a virtual location of the satellite to the terminal, wherein the assistance information is information calculated by the terminal based on the information on the virtual location of the satellite.

According to a second exemplary embodiment of the present disclosure, a method of a terminal may comprise: receiving, from a satellite, a request signal requesting to periodically report assistance information for round-trip time calculation, the request signal including a reporting periodicity and a type of assistance information; generating the assistance information according to the request signal; and periodically reporting the generated assistance information to the satellite.

When the type of assistance information is a required transmission time, the generating of the assistance information according to the request signal may comprise: receiving a downlink signal from the satellite base station; calculating an arrival time of the downlink signal; calculating a transmission time of a response signal to the downlink signal; and calculating the required transmission time, which is a time difference between the arrival time and the transmission time, as the assistance information.

When the type of assistance information is a timing advance (TA), the terminal may use a TA with respect to the satellite as the assistance information.

The method may further comprise: receiving ephemeris information from the satellite, and the generating of the assistance information according to the request signal may comprise: predicting movement locations of the satellite based on the ephemeris information; and generating the assistance information based on the predicted locations of the satellite.

The method may further comprise: receiving information on a virtual location of the satellite from the satellite, and the generating of the assistance information according to the request signal may comprise: identifying the virtual location of the satellite; and generating the assistance information based on the virtual location of the satellite.

According to a third exemplary embodiment of the present disclosure, a terminal may comprise a processor, wherein the processor may cause the terminal to perform: receiving, from a satellite, a request signal requesting to periodically report assistance information for round-trip time calculation, the request signal including a reporting periodicity and a type of assistance information; generating the assistance information according to the request signal; and periodically reporting the generated assistance information to the satellite.

When the type of assistance information is a required transmission time, in the generating of the assistance information according to the request signal, the processor may further cause the terminal to perform: receiving a downlink signal from the satellite base station; calculating an arrival time of the downlink signal; calculating a transmission time of a response signal to the downlink signal; and calculating the required transmission time, which is a time difference between the arrival time and the transmission time, as the assistance information.

When the type of assistance information is a timing advance (TA), the terminal may use a TA with respect to the satellite as the assistance information.

The processor may further cause the terminal to perform: receiving ephemeris information from the satellite, and in the generating of the assistance information according to the request signal, the processor may further cause the terminal to perform: predicting movement locations of the satellite based on the ephemeris information; and generating the assistance information based on the predicted locations of the satellite.

The processor further cause the terminal to perform: receiving information on a virtual location of the satellite from the satellite, and in the generating of the assistance information according to the request signal, the processor may further cause the terminal to perform: identifying the virtual location of the satellite; and generating the assistance information based on the virtual location of the satellite.

According to the present disclosure, a satellite can calculate a round-trip time with respect to a terminal through specific time information, timing advance, etc. reported by the terminal. Further, according to the present disclosure, the satellite can calculate a location of the terminal using specific time information periodically received from the terminal. Further, according to the present disclosure, the satellite can estimate the location of the terminal using information on the terminal received from another satellite.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a sequence chart illustrating a first exemplary embodiment of a location estimation method in a communication system.

FIG. 5 is a conceptual diagram illustrating a first exemplary embodiment of a required transmission time.

FIG. 6 is a conceptual diagram illustrating a first exemplary embodiment of a timing advance of a terminal.

FIG. 7 is a conceptual diagram illustrating a first exemplary embodiment of a method for estimating a location of a terminal.

FIG. 8 is a conceptual diagram illustrating a second exemplary embodiment of a method for estimating a location of a terminal.

FIG. 9 is a conceptual diagram illustrating a third exemplary embodiment of a method for estimating a location of a terminal.

FIG. 10 is a conceptual diagram illustrating a fourth exemplary embodiment of a method for estimating a location of a terminal.

FIG. 11 is a conceptual diagram illustrating a fifth exemplary embodiment of a method for estimating a location of a terminal.

FIG. 12 is a conceptual diagram illustrating a sixth exemplary embodiment of a method for estimating a location of a terminal.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g., long-term evolution (LTE) communication network), a 5G communication network (e.g., new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

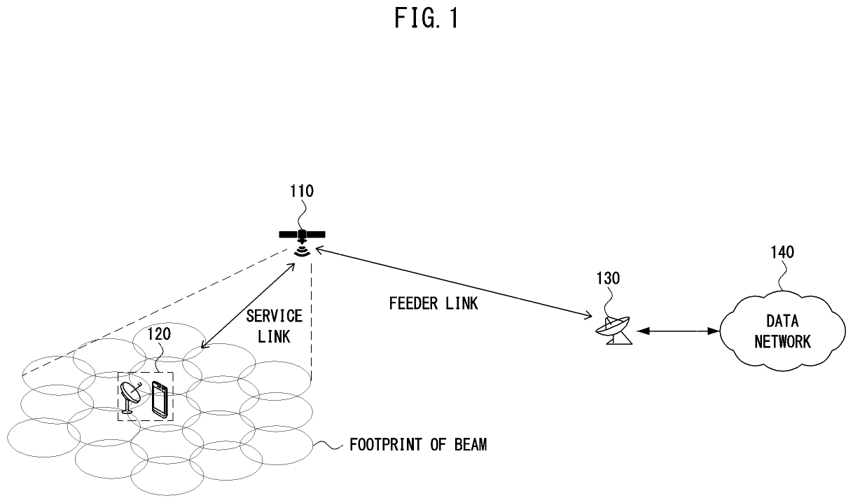

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g., a user equipment (UE) or a terminal) located on a terrestrial site and a communication node (e.g., an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g., downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g., base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g., AMF, UPF, SMF, and the like) may be performed based on an NG-C/U interface.

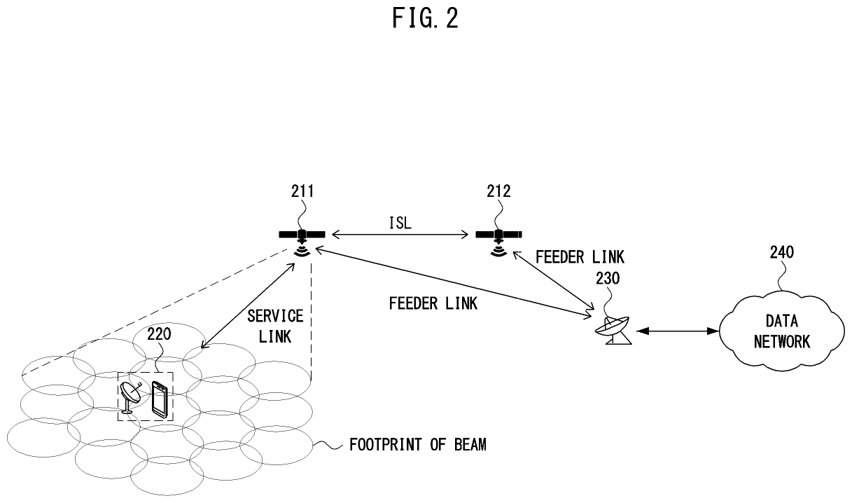

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using LTE technology and/or NR technology. The communications between the satellite 211 and the communication node 220 may be performed using an NR-Uu interface. When DC is supported, the communication node 220 may be connected to other base stations (e.g., base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g., AMF, UPF, SMF, and the like) may be performed based on an NG-C/U interface.

Meanwhile, entities (e.g., satellites, communication nodes, gateways, etc.) constituting the NTNs shown in FIGS. 1 and 2 may be configured as follows.

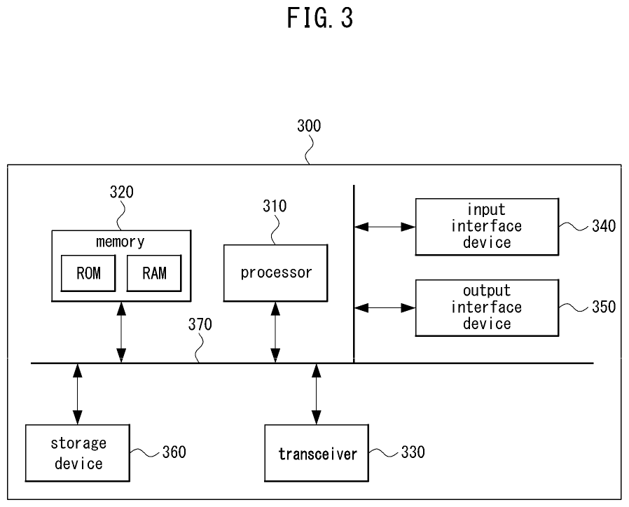

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g., a GEO satellite that supports a transparent function), this may be referred to as ‘scenario A’. When the satellites 211 and 212 in the NTN shown in FIG. 2 are GEO satellites (e.g., GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |
| | | | 1,200 | km |
| Spectrum (service link) | <6 GHz (e.g., 2 GHz) | | | |
| | >6 GHz (e.g., DL 20 GHz, UL 30 GHz) | | | |
| Maximum channel | 30 MHz for band <6 GHz | | | |
| bandwidth capability | 1 GHz for band >6 GHz | | | |
| (service link) | | | | |

| Maximum distance between | 40,581 | km | 1,932 km (altitude of 600 km) |
|---|---|---|---|
| satellite and communication | | | 3,131 km (altitude of 1,200 km) |
| node (e.g., UE) at the | | | |
| minimum elevation angle | | | |
| Maximum round trip delay | Scenario A: 541.46 ms | | Scenario C: (transparent |
| (RTD) (only propagation | (service and feeder links) | | payload: service and feeder |
| delay) | Scenario B: 270.73 ms (only | | links) |
| | service link) | | −5.77 ms (altitude of 60 0 km) |
| | | | −41.77 ms (altitude of 1,200 km) |
| | | | Scenario D: (regenerative |
| | | | payload: only service link) |
| | | | −12.89 ms (altitude of 600 km) |
| | | | −20.89 ms (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |
| within a cell | | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | | Scenario | |
|---|---|---|---|---|---|---|
| | A | B | C1-2 | | D1-2 | |
| Satellite altitude | 35,786 km | | 600 km | | | |
| Maximum RTD in a | 541.75 ms | 270.57 ms | 28.41 | ms | 12.88 | ms |
| radio interface | (worst case) | | | | | |
| between base station | | | | | | |
| and UE | | | | | | |
| Minimum RTD in a | 477.14 ms | 238.57 ms | 8 | ms | 4 | ms |
| radio interface | | | | | | |
| between base station | | | | | | |
| and UE | | | | | | |

Meanwhile, a communication system may prepare for communication disruptions that may occur in cellular shadow areas, such as mountainous areas, desert areas, islands, and oceans, as well as in areas where terrestrial networks are disrupted due to various disasters such as earthquakes, tsunamis, and war. For this purpose, a spatial mobile communication network may be required. Since the spatial mobile communication network is maintained even when terrestrial networks are disrupted due to disaster or calamity, the area where the disaster or calamity occurred may not be disconnected from the outside world, making it possible to maintain individual survival and safety. Additionally, the spatial mobile communication network may be required to construct a hyper-connected society by providing mobile communication services to areas where communication was previously impossible, such as mountainous and remote areas without communication infrastructure.

The 3rd Generation Partnership Project (3GPP) is advancing the standardization of a non-terrestrial network (NTN) utilizing non-terrestrial base stations (such as satellite base stations or airborne platforms like airships) based on 5G New Radio (NR) technology.

Meanwhile, when the non-terrestrial base station is a satellite base station, the distance between the satellite base station and a terminal may be long, and the location of the satellite base station may continuously change. An NTN constructed in such a spatial mobile communication system may have a relatively long round trip time (RTT) delay and a high Doppler shift environment compared to terrestrial communications. In this case, the long RTT may affect various procedures of data transmission/reception. Accordingly, in the NTN, if appropriate timing adjustment is not performed in the terminals, signals arriving at the base station from terminals located at various distances may have large differences in arrival times. Additionally, cell coverage may be large in the NTN, and division of cell coverage into extra-territorial regions may be required. Therefore, the NTN may necessitate a network-based terminal location estimation method suitable for long-distance communication.

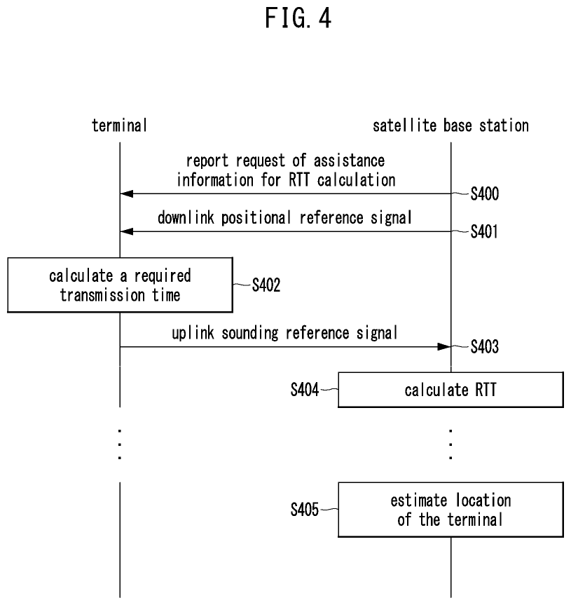

FIG. 4 is a sequence chart illustrating a first exemplary embodiment of a location estimation method in a communication system.

Referring to FIG. 4, in a location estimation method, a satellite base station may transmit a report request signal requesting a terminal to periodically report assistance information for round trip time (RTT) calculation (S400). The report request signal may indicate a reporting periodicity and a type of assistance information. Here, the reporting periodicity may be set in slot units, time units, or the like. As an example, the reporting periodicity may be 1 ms. In addition, the type of assistance information may include a required transmission time, timing advance (TA), and/or the like.

Then, the terminal may receive the report request signal from the satellite base station indicating the reporting periodicity and type of assistance information, which requests to report assistance information for RTT calculation. In this case, the type of assistance information may be a required transmission time. In this case, the satellite base station may transmit a downlink positioning reference signal (DL PRS) to the terminal (S401), and the terminal may receive the DL PRS from the satellite base station. In addition, the terminal may calculate a required transmission time based on the DL PRS received from the satellite base station (S402). In this case, the terminal may calculate the required transmission time as a time obtained by subtracting a time of transmitting an uplink sounding reference signal (UL SRS) from a time of receiving the DL PRS.

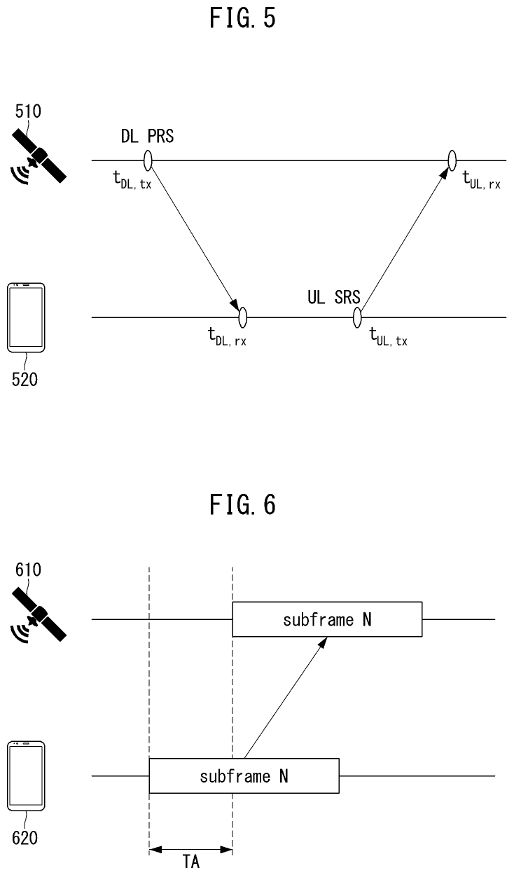

FIG. 5 is a conceptual diagram illustrating a first exemplary embodiment of a required transmission time.

Referring to FIG. 5, a satellite base station 510 may transmit a DL PRS to a terminal 520. Here, a time at which the satellite base station transmits the DL PRS may be t_{DL,tx}. Accordingly, the terminal may receive the DL PRS from the satellite base station. Here, a time at which the terminal receives the DL PRS may be t_{DL,rx}.

Meanwhile, the terminal may transmit a UL SRS to the satellite base station after receiving the DL PRS from the satellite base station. Here, a time at which the terminal transmits the UL SRS may be t_{UL,tx}. Accordingly, the terminal may calculate t_{UL,tx}-t_{DL,rx} as a required transmission time.

Referring again to FIG. 4, the terminal may transmit a UL SRS including (or, along with) information on the required transmission time to the satellite base station (S403). Then, the satellite base station may receive the UL SRS including information on the required transmission time from the terminal. In this case, a time at which the satellite base station receives the SRS may be t_{UL,rx}. Accordingly, the base station may identify the time of transmitting the DL PRS, the required transmission time, and the time of receiving the SRS. Accordingly, the base station may calculate an RTT using the time of transmitting the DL-PRS, required transmission time, and time of receiving the SRS (S404).

Here, the RTT may be a value obtained by subtracting a UL/DL time difference at the terminal from a UL/DL time difference at the satellite base station. In this case, the UL/DL time difference at the satellite base station may be defined as t_{UL,rx}-t_{DL,tx}, and the UL/DL time difference at the terminal may be defined as t_{UL,tx}-t_{DL,rx}. Accordingly, the RTT may be expressed as in Equation 1 below.

$$RTT = ( {t}_{U L , r x} - {t}_{D L , t x} ) - ( {t}_{U L , t x} - {t}_{D L , r x} ) \qquad [ Equation 1 ]$$

The terminal may report the UL/DL time difference at the terminal to the satellite base station, and the satellite base station may receive the UL/DL time difference from the terminal. The satellite base station may calculate the RTT using the UL/DL time difference at the satellite base station and the UL/DL time difference at the terminal.

On the other hand, the type of assistance information may be a TA. In this case, the terminal may transmit information on the TA to the satellite base station. Accordingly, the satellite base station may receive the information on the TA from the terminal, and calculate an RTT by referring to the received TA.

FIG. 6 is a conceptual diagram illustrating a first exemplary embodiment of a timing advance of a terminal.

Referring to FIG. 6, a terminal 620 may transmit a subframe N to a satellite base station 610, and the satellite base station may receive the subframe N from the terminal. Here, N may be a real number. In this case, a difference between a time at which the terminal transmits the subframe N and a time at which the satellite base station receives the subframe N from the terminal may be a TA. The terminal may report its TA to the satellite base station, and the satellite base station may receive information on the TA from the terminal. Accordingly, the satellite base station may use the information on the TA received from the terminal to calculate an RTT.

As described above, the satellite base station may acquire the RTT using one of the following methods.

Method 1: The satellite base station may calculate and obtain the RTT based on Equation 1 using a UL/DL time difference at the terminal, which is received from the terminal.

Method 2: The satellite base station may calculate and obtain the RTT using the TA received from the terminal.

Method 3: The satellite base station may select one of timing advances already received from the terminal and use it to obtain the RTT.

Here, the TA may be a terminal-specific TA reported by a MAC control element (CE). The granularity of TA reporting may be 1 ms as an example. Meanwhile, the terminal may report a beam or cell identifier (ID) to the satellite base station, and the satellite base station may receive the beam/cell ID from the terminal.

Referring again to FIG. 4, the terminal may periodically transmit assistance information for RTT calculation to the satellite base station, and the satellite base station may periodically receive the assistance information from the terminal. Accordingly, the satellite base station may calculate RTTs between the satellite and the terminal at various locations of the satellite. In addition, the satellite may calculate distances between the satellite and the terminal using the RTTs between the satellite and the terminal calculated at various locations of the satellite. In addition, the satellite base station may estimate the location of the terminal using the distances between the satellite and the terminal calculated at various locations of the satellite (S405).

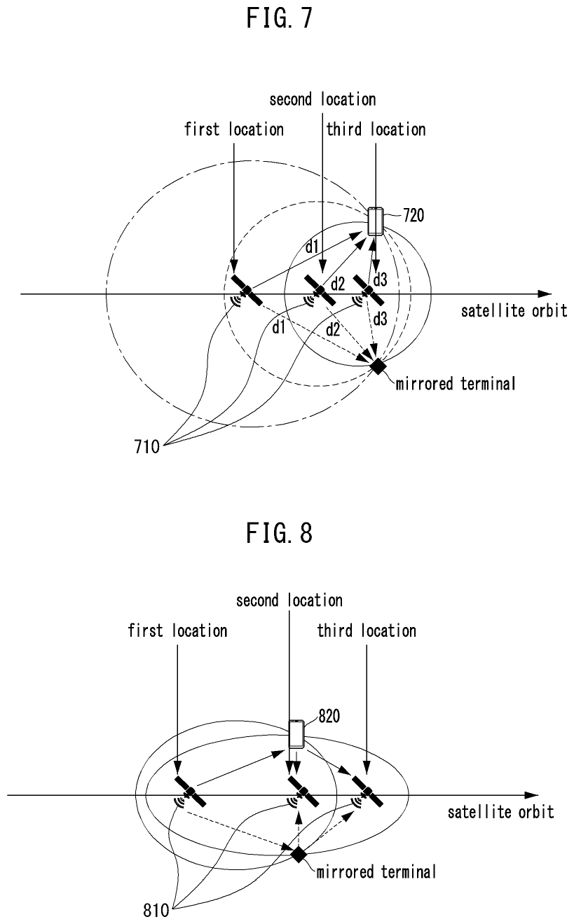

FIG. 7 is a conceptual diagram illustrating a first exemplary embodiment of a method for estimating a location of a terminal.

Referring to FIG. 7, a satellite base station 710 may obtain a first RTT using assistance information received at a first location as it moves to various locations, and the satellite base station 710 may calculate a first distance d1 between the satellite and a terminal 720 by using the first RTT. In addition, the satellite base station 710 may obtain a second RTT using assistance information received at a second location, and may calculate a second distance d2 between the satellite base station 710 and the terminal 720 by using the second RTT. In addition, the satellite base station 710 may obtain a third RTT using assistance information received at a third location, and may calculate a third distance d3 between the satellite base station 710 and the terminal 720 by using the third RTT.

The satellite base station may assume that each measured RTT corresponds to a circle which is a set of potential locations of the terminal. Accordingly, the satellite base station may assume an intersection of circles based on the RTTs as the location of the terminal. In this case, there may be two intersections of the circles. Here, one intersection may be the location of the actual terminal, and the other intersection may be a location of a mirrored terminal. In this reason, accurate estimation of the location of the actual terminal may be impossible due to these two intersections when the RTT measurement is performed with respect to a single satellite moving along a line.

FIG. 8 is a conceptual diagram illustrating a second exemplary embodiment of a method for estimating a location of a terminal.

Referring to FIG. 8, a satellite base station 810 may obtain a first RTT using assistance information received at a first location as it moves to various locations, and may obtain the first location of the satellite base station 810 by using the first RTT. In addition, the satellite base station 810 may obtain a second RTT using assistance information received at a second location, and may obtain the second location of the satellite base station 810 by using the second RTT. In addition, the satellite base station 810 may obtain a third RTT using assistance information received at a third location, and may obtain the third location of the satellite base station 810 by using the third RTT.

Accordingly, the satellite base station may form a first ellipse by using the first location as a first focus and using the second location as a second focus. Additionally, the satellite base station may form a second ellipse by using the first location as a first focus and using the third location as a second focus. The satellite base station may estimate the location of the terminal by using these ellipses. In this case, there may be two intersections of the ellipses. One intersection may be the location of the actual terminal, and the other intersection may be the location of a mirrored terminal. In this reason, accurate estimation of the location of the actual terminal may be impossible due to these two intersections when the RTT measurement is performed with respect to a single satellite moving along a line.

In order to resolve the above-described ambiguity in determining the location of the terminal, the satellite base station may consider beam/cell deployment or an uplink angle of arrival (AoA). In other words, the terminal may report a beam or cell identifier (ID) to the satellite base station. Then, the satellite base station may mitigate the ambiguity of the location of the terminal due to a mirror image by considering the beam/cell ID reported by the terminal together with the RTT. Alternatively, the satellite may measure an uplink AoA and use it to determine the location of the terminal, thereby mitigating the ambiguity of the location of the terminal due to a mirror image.

In other words, the satellite base station may calculate an angle of arrival when receiving an uplink signal from the terminal. Additionally, the satellite base station may use the calculated angle of arrival to remove the mirrored location of the terminal and specify the actual location of the terminal.

Meanwhile, the satellite base station may estimate the exact location of the terminal by utilizing another base station with a different cell size or located in a different location. For example, the satellite base station may utilize a terrestrial base station or another satellite base station located at a different altitude. The terminal may transmit signaling for RTT to each base station connected in a dual connectivity situation. A specific base station among base stations may indicate the terminal to proceed with a procedure for location estimation. Each base station may estimate the location of the terminal by sharing the estimated RTTs.

In this case, the satellite base station may receive information on two estimated locations of the terminals, which are estimated by another satellite base station or a terrestrial base station in the same manner. In addition, the satellite base station may determine the location of the actual terminal by identifying a matching location among the two locations estimated by the satellite base station and the two estimated locations received from another satellite base station or terrestrial base station.

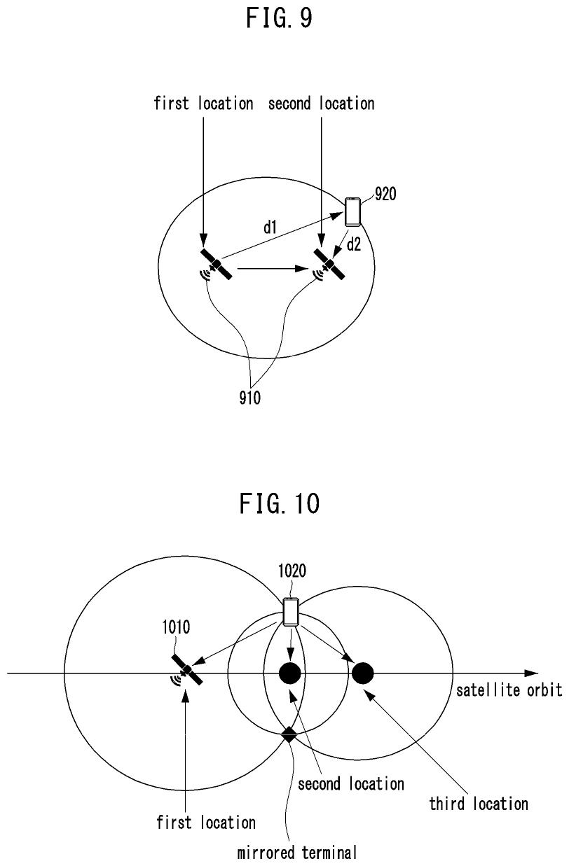

Meanwhile, the satellite base station may calculate RTTs by receiving assistance information from other terminals, and the satellite base station may select another terminal with an RTT that is the least different from the RTT of the target terminal. In this case, the satellite base station may already know the location of the another terminal. As a result, the satellite base station may specify a location closest to the location of the another terminal among the two locations of the terminal as the location of the actual terminal. Here, the satellite base station may use ellipses rather than circles, as shown in FIG. 9, to find the locations of the corresponding terminal.

FIG. 9 is a conceptual diagram illustrating a third exemplary embodiment of a method for estimating a location of a terminal.

Referring to FIG. 9, a satellite base station 910 may obtain a first RTT using assistance information received at a first location as it moves to various locations, and the satellite base station 910 may obtain the first location and a first distance d1 of the satellite base station 910 by using the first RTT. In addition, the satellite base station 910 may obtain a second RTT using assistance information received at a second location, and may obtain the second location and a second distance d2 of the satellite base station 910 by using the second RTT. Accordingly, the satellite base station may form an ellipse by using the first location as a first focus and using the second location as a second focus. Here, a thickness of the ellipse may represent a timing error and an RTT error. The ellipse may be drawn actually in three dimensions due to a height of the satellite base station, but for simplicity it may be represented here in two dimensions.

In this situation, a sum of the first distance from the first focus to the terminal and the second distance from the second focus to the terminal may be d1+d2. Here, a set of points on the ellipse, which are points corresponding to (d1+d2), may be candidate locations for the terminal 920. The satellite base station may transmit a signal for RTT measurement to terminals whose locations have already been verified that exist in the candidate locations. Through this, the satellite base station 910 may identify already verified terminals that have a similar RTT value to the RTT value of the terminal 920. The satellite base station 910 may determine the location of the terminal 920 by using the location of a terminal with a similar RTT value. As described above, the satellite base station may mitigate ambiguity regarding a mirror image by determining the location of the terminal based on an area to which the already verified terminal belongs. Alternatively, for more accurate location estimation, the satellite base station may estimate the location within the area by interpolating the location of the terminal 920 based on the locations of already verified terminals.

The satellite base station may know the RTTs of already verified terminals, and may receive a beam/cell ID along with signaling for RTT from the terminal 920 for location estimation. The satellite base station may alleviate ambiguity regarding a mirror image by determining that the terminal 920 is located in the area where a verified terminal with a similar RTT value and the same beam/cell ID are present. This method may be applied when the satellite moves at such a high speed that a difference between its original location at a start time of the RTT measurement and its subsequent location at an end time of the RTT measurement is not negligible.

Meanwhile, the measurement of multiple RTTs described above may be performed considering the actual movement of the satellite. This may mean that the satellite is considered to be actually located at a location corresponding to each RTT. However, the satellite may not be actually located at the satellite's reference locations for multiple RTT measurements. Even in this case, the terminal may assume that the satellite is actually present at the reference locations. In the NTN, the terminal may receive and manage satellite ephemeris broadcasted from the satellite. Accordingly, the terminal may know the location of the satellite at a specific time using the satellite ephemeris. As a result, the terminal may report multiple RTT measurements using predefined satellite locations according to the satellite ephemeris. This can lead to reduce a latency for multiple RTT reporting.

FIG. 10 is a conceptual diagram illustrating a fourth exemplary embodiment of a method for estimating a location of a terminal.

Referring to FIG. 10, a first location may be an actual location of a satellite 1010, and a second location and a third location may be predicted locations of the satellite according to ephemeris information of the satellite 1010. The satellite 1010 may transmit the ephemeris information to a terminal 1020, and the terminal 1020 may receive the ephemeris information from the satellite 1010. Since the terminal 1020 already knows the ephemeris information, the terminal 1020 may predict RTTs according to the predicted locations (i.e. second and third locations) of the satellite, and report assistance information predicted based thereon to the satellite. The satellite base station may estimate a potential location of the terminal using the assistance information reported from the terminal.

Here, multi-RTT measurement using satellite locations predicted based on ephemeris information has be described. This method may be generalized to multi-RTT measurement using arbitrarily predefined locations as well as predefined locations along a single line.

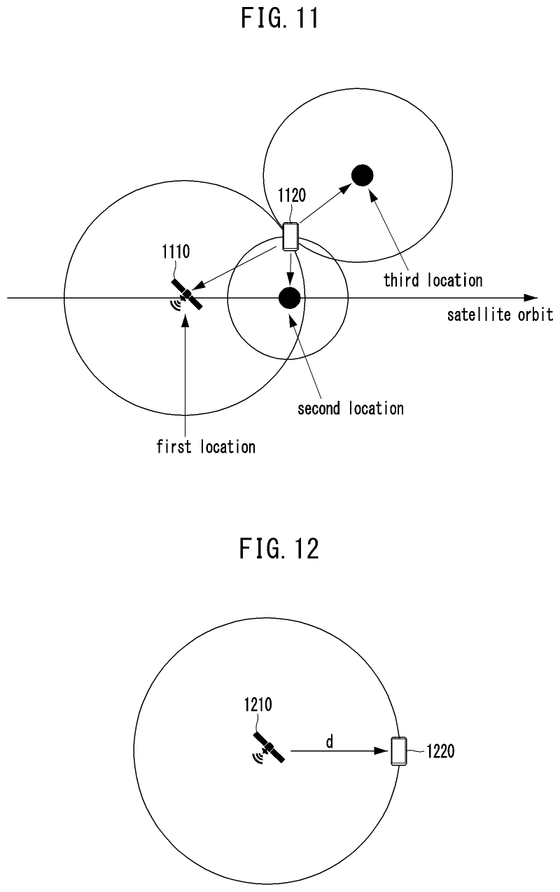

FIG. 11 is a conceptual diagram illustrating a fifth exemplary embodiment of a method for estimating a location of a terminal.

Referring to FIG. 11, a first location may be an actual location of a satellite 1110. On the other hand, a second location and a third location may be predefined or preconfigured locations of the satellite. The first location, which is the actual location of the satellite, and the second and third locations, which are virtual locations of the satellite, may not be on one line. In addition, the satellite base station may predefine the three locations, and the satellite base station may inform the terminal 1120 of information on the three locations in advance. The terminal may calculate assistance information based on the three locations received from the satellite base station, and report the assistance information to the satellite base station. Here, the terminal may report multiple RTTs according to the second and third locations to the satellite. Accordingly, the satellite may remove a mirrored terminal, and identify the location of the actual terminal. In this method, the network can estimate the location of the terminal without mirror image ambiguity.

FIG. 12 is a conceptual diagram illustrating a sixth exemplary embodiment of a method for estimating a location of a terminal.

Referring to FIG. 12, a satellite base station 1210 may calculate a distance d of a terminal 1220 using RTT information. The satellite base station may form a circle indicating candidate locations of the terminal 1220 by calculating the distance d according to a specific RTT. Here, a thickness of the circle may represent a timing error and an RTT error. The circle may be drawn actually in three dimensions due to a height of the satellite station, but for simplicity it may be represented here in two dimensions.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a satellite, comprising:
transmitting a request signal requesting a terminal to periodically report assistance information for round-trip time calculation;
receiving the assistance information periodically reported from the terminal;
calculating round-trip times based on the assistance information; and
estimating a location of the terminal using the round trip times.

2. The method according to claim 1, wherein the assistance information is a required transmission time, which is a time difference between an arrival time of a downlink signal transmitted from the satellite to the terminal and a transmission time of an uplink signal in response to the downlink signal, and in the calculating of the round-trip times based on the assistance information, the satellite calculates the round-trip times using the required transmission times which are the periodically reported assistance information.

3. The method according to claim 1, wherein the assistance information is a timing advance, and in the calculating of the round-trip times based on the assistance information, the satellite calculates the round-trip times using the timing advances which are the periodically reported assistance information.

4. The method according to claim 1, wherein the estimating of the location of the terminal using the round trip times comprises:
calculating distances between the terminal and the satellite using the round-trip times; and
estimating the location of the terminal based on the distances.

5. The method according to claim 4, further comprising:
when a plurality of locations are estimated, calculating an angle of arrival for an uplink signal transmitted from the terminal; and
determining one actual location from the plurality of locations using the calculated angle of arrival.

6. The method according to claim 4, further comprising:
when a plurality of locations are estimated, acquiring a location of another terminal having round trip times closest to the calculated round trip times; and
obtaining one actual location from the plurality of locations based on the acquired location of the another terminal.

7. The method according to claim 1, further comprising: transmitting ephemeris information of the satellite to the terminal, wherein the assistance information is information calculated by the terminal based on predicted locations of the satellite based on the ephemeris information.

8. The method according to claim 1, further comprising: transmitting information on a virtual location of the satellite to the terminal, wherein the assistance information is information calculated by the terminal based on the information on the virtual location of the satellite.

9. A method of a terminal, comprising:
receiving, from a satellite, a request signal requesting to periodically report assistance information for round-trip time calculation, the request signal including a reporting periodicity and a type of assistance information;
generating the assistance information according to the request signal; and
periodically reporting the generated assistance information to the satellite.

10. The method according to claim 9, wherein when the type of assistance information is a required transmission time, the generating of the assistance information according to the request signal comprises:
receiving a downlink signal from the satellite base station;
calculating an arrival time of the downlink signal;
calculating a transmission time of a response signal to the downlink signal; and
calculating the required transmission time, which is a time difference between the arrival time and the transmission time, as the assistance information.

11. The method according to claim 9, wherein when the type of assistance information is a timing advance (TA), the terminal uses a TA with respect to the satellite as the assistance information.

12. The method according to claim 9, further comprising: receiving ephemeris information from the satellite, and the generating of the assistance information according to the request signal comprises:
predicting movement locations of the satellite based on the ephemeris information; and
generating the assistance information based on the predicted locations of the satellite.

13. The method according to claim 9, further comprising: receiving information on a virtual location of the satellite from the satellite, and the generating of the assistance information according to the request signal comprises:
identifying the virtual location of the satellite; and
generating the assistance information based on the virtual location of the satellite.

14. A terminal comprising a processor,
wherein the processor causes the terminal to perform:
receiving, from a satellite, a request signal requesting to periodically report assistance information for round-trip time calculation, the request signal including a reporting periodicity and a type of assistance information;
generating the assistance information according to the request signal; and
periodically reporting the generated assistance information to the satellite.

15. The terminal according to claim 14, wherein when the type of assistance information is a required transmission time, in the generating of the assistance information according to the request signal, the processor further causes the terminal to perform:
receiving a downlink signal from the satellite base station;
calculating an arrival time of the downlink signal;
calculating a transmission time of a response signal to the downlink signal; and
calculating the required transmission time, which is a time difference between the arrival time and the transmission time, as the assistance information.

16. The terminal according to claim 14, wherein when the type of assistance information is a timing advance (TA), the terminal uses a TA with respect to the satellite as the assistance information.

17. The terminal according to claim 14, wherein the processor further causes the terminal to perform: receiving ephemeris information from the satellite, and in the generating of the assistance information according to the request signal, the processor further causes the terminal to perform:
predicting movement locations of the satellite based on the ephemeris information; and
generating the assistance information based on the predicted locations of the satellite.

18. The terminal according to claim 14, wherein the processor further causes the terminal to perform: receiving information on a virtual location of the satellite from the satellite, and in the generating of the assistance information according to the request signal, the processor further causes the terminal to perform:
identifying the virtual location of the satellite; and
generating the assistance information based on the virtual location of the satellite.
